(19) United States
(12) Patent Application Publication
(10) Pub. No.: US 2025/0383818 A1
(43) Pub. Date: Dec. 18, 2025

(54) DATA PRIORITIZATION FOR BOOT-UP PROCEDURES

(71) Applicant: Micron Technology, Inc., Boise, ID (US)

(72) Inventors: Francesco Basso, Portici (NA) (IT); Luigi Paglialunga, Frattamaggiore (NA) (IT); Rosa Nuzzo, Acerra (NA) (IT); Francesco Falanga, Quarto (NA) (IT); Massimo Iaculo, San Marco Evangelista (CE) (IT)

(21) Appl. No.: 19/229,973

(22) Filed: Jun. 5, 2025

Related U.S. Application Data
(60) Provisional application No. 63/660,289, filed on Jun. 14, 2024.

(51) Int. Cl. G06F 3/06

(52) U.S. Cl. CPC G06F 3/0659; G06F 3/0604; G06F 3/0634; G06F 3/0673

(57) ABSTRACT

Methods, systems, and devices for data prioritization for boot-up procedures are described. A host system may include a parameter in a write command indicating a priority level associated with data, such as data associated with a firmware image. A memory system may identify the parameter in the write command and store or maintain the data in memory cells of a first type after a memory management operation. For example, the memory system may either refrain from transferring the data after the memory management operation or transfer the data to different memory cells of the first type. The memory system may prefetch the data by preemptively moving the data to a buffer, such as prior to receiving a read command. After a read command for the data is received, the data may be transferred from the buffer to the host system to satisfy the command.

### CROSS REFERENCE

The present Application for Patent claims priority to U.S. Patent Application No. 63/660,289 by Basso et al., entitled “DATA PRIORITIZATION FOR BOOT-UP PROCEDURES,” filed Jun. 14, 2024, which is assigned to the assignee hereof, and which is expressly incorporated by reference in its entirety herein.

### TECHNICAL FIELD

The following relates to one or more systems for memory, including data prioritization for boot-up procedures.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data prioritization for boot-up procedures in accordance with examples as disclosed herein.

FIG. 2 shows an example of a memory system that supports data prioritization for boot-up procedures in accordance with examples as disclosed herein.

FIG. 3 shows an example of a process that supports data prioritization for boot-up procedures in accordance with examples as disclosed herein.

FIG. 4 shows a block diagram of a memory system that supports data prioritization for boot-up procedures in accordance with examples as disclosed herein.

FIG. 5 shows a flowchart illustrating a method or methods that support data prioritization for boot-up procedures in accordance with examples as disclosed herein.

### DETAILED DESCRIPTION

During a boot-up procedure, a memory system may experience latency associated with loading a firmware image. For example, data associated with the firmware image may be loaded to a set of memory cells of a memory device prior to a soldering operation (e.g., soldering the memory device to a board). After the memory device is soldered and booted, the data associated with the firmware image may be transferred from a first set of memory cells of a first type to a second set of memory cells of a second type. For example, the data may be transferred from single level cells (SLCs) to triple level cells (TLCs). Loading the firmware image in examples in which the data associated with the firmware image is stored in the TLCs may increase latency associated with the boot-up procedure, as reading the data from the TLCs may be relatively slow relative to other types of memory cells, such as SLCs.

As described herein, a host system may include a parameter in a write command indicating a priority level associated with data, such as the data associated with the firmware image. The memory system may identify the parameter in the write command and store or maintain the data in memory cells of the first type (e.g., SLCs) after the soldering operation. For example, the memory system may either refrain from transferring the data after the soldering operation or transfer the data to different memory cells of the first type (e.g., to different SLCs). The memory system may prefetch the data by preemptively moving the data to a buffer, such as prior to receiving a read command. When a read command for the data is received, the data may be transferred from the buffer to the host system to satisfy the command. By transferring the data to the buffer prior to receiving the read command and by storing the data associated with the priority level in the first type of memory cells, the memory system may reduce a latency associated with loading the firmware image during the boot-up procedure.

In addition to applicability in memory systems as described herein, techniques for data prioritization during boot-up procedures may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease latency times, improve response times, or otherwise improve user experience, among other benefits.

Features of the disclosure are illustrated and described in the context of systems, devices, and circuits. Features of the disclosure are further illustrated and described in the context of processes and flowcharts.

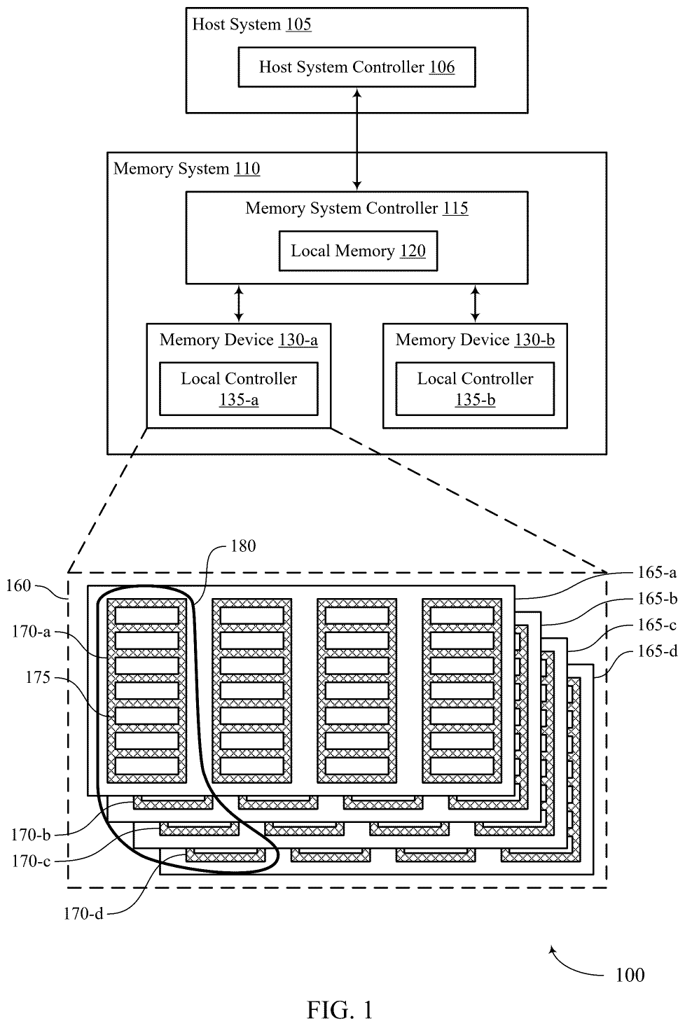

FIG. 1 shows an example of a system 100 that supports data prioritization for boot-up procedures in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as TLCs if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The host system 105 and the memory system 110 may support techniques for reducing a latency associated with loading a firmware image during a boot-up procedure. For example, the memory system 110 may reduce the latency associated with loading the firmware image by prefetching firmware image data prior to receiving a read command. The host system 105 may provide, in a write command, an indication of high priority data, such as the firmware image data. According to the indication, the memory system 110 may write and maintain the high priority data in memory cells of a first type associated with the high priority (e.g., SLCs). Additionally, the memory system 110 may transfer the high priority data to a buffer prior to receiving the read command from the host system 105.

The system 100 may include any quantity of non-transitory computer readable media that support data prioritization for boot-up procedures. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

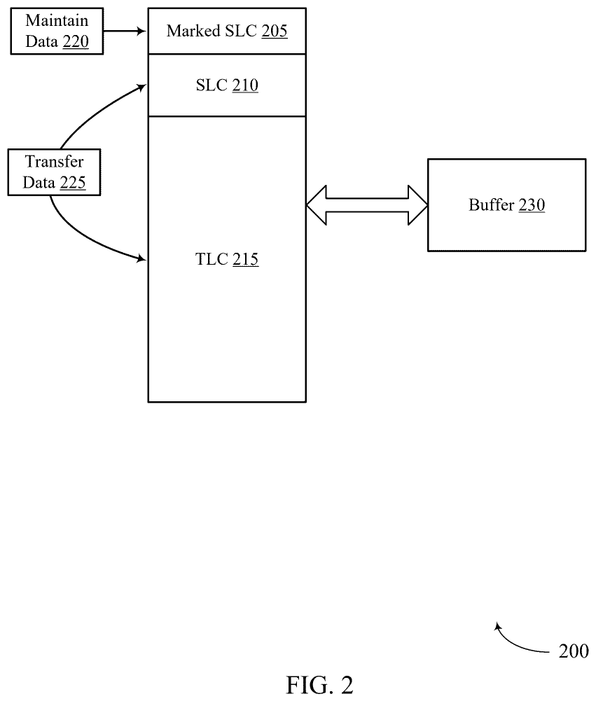

FIG. 2 shows an example of a memory system 200 that supports data prioritization for boot-up procedures in accordance with examples as disclosed herein. The memory system 200 may be an example of a system 100 as described with reference to FIG. 1, or aspects thereof. For example, the memory system 200 may be an example of the memory system 110 as described with reference to FIG. 1. The memory system 200 may be configured to store data received from a host system and to send data to a host system, if requested by the host system using access commands (e.g., read commands or write commands).

A host system may load or pre-program a memory device, such as a memory device of the memory system 200 described herein, with data (e.g., system code or other relevant data) prior to the memory device being soldered onto a platform (e.g., a board). The loading or pre-programming prior to the soldering may be referred to as a production state awareness (PSA) pre-soldering operation. For example, the host system may set a size of data to be pre-written to the memory device, and the memory device may determine whether to store the data in an SLC 210 or in the SLC 210 and a TLC 215. The SLC 210 may be associated with greater resiliency with respect to thermal stresses associated with the soldering operation, and, accordingly, the memory device may store all the data in the SLC 210 in examples in which the size of the data does not exceed a size of the SLC 210. That is, the memory device may store data exceeding a size of the SLC 210 in the TLC 215.

After loading or pre-programming the memory device, the memory device may be soldered onto the platform. The soldering operation may be associated with high temperature or thermal stresses. In some cases, the thermal stresses associated with the soldering operation may be associated with damage to memory cells of the memory device, including voltage threshold shifts. The memory device may perform a refresh operation in response to the soldering operation. For example, the memory device may perform the refresh operation to compensate for the damage to the memory cells. The refresh operation may involve reading the data stored in the SLC 210 or the SLC 210 and the TLC 215, correcting errors in the data, and storing the data. For example, the memory device may re-store the data in the TLC 215.

As described herein, the host system and the memory system 200 may support maintenance of data associated with a priority level, such as firmware image data, in the SLC 210 prior to and after the soldering operation. For example, the host system may indicate data associated with a high priority level relative to other data via a parameter in a write command. The data associated with the high priority level may refer to firmware image data or data otherwise associated with an early stage of the host system, the memory system, or both. For example, the data associated with the high priority level may be used by the memory system 200 during a bootup procedure (e.g., the data may be used to boot the memory system 200). Additionally, or alternatively, the data associated with the high priority level may be data with a low probability of being rewritten (e.g., platform in normal working may not rewrite often).

A priority level may refer to host high priority data (HHPD). As an example, the parameter may be a group number. The group number may refer to a parameter in a UFS protocol of a bit length (e.g., 5 bits). In some cases, the group number may be used to notify a target device that the data has system data characteristics or is linked to a context identifier (ID). Different group numbers may be associated with different priority levels. For example, the host system may use a first group number or a first group number value (e.g., a numeric sequence) to indicate high priority data, a second group number to indicate low priority data, and so on. Additionally, or alternatively, the write command may be an example of an SCSI write command (e.g., in the UFS protocol). In some examples, the host system may identify the data associated with the high priority level via LBAs. For example, the write command may be associated with a set of LBAs which are tagged by the host system as being high priority.

The memory system 200 may allocate the data associated with the high priority into a marked SLC 205 in accordance with the indication. For example, the memory system 200 may include a set of memory cells reserved for storage of data associated with the high priority level. That is, during a pre-soldering operation in which data is loaded to the memory device, the data associated with the high priority may be stored in the marked SLC 205 rather than the SLC 210 or the TLC 215. Additionally, or alternatively, the memory system 200 may perform a refresh operation after a soldering operation in accordance with the indication. For example, the memory system 200 may maintain data 220 in the marked SLC 205 after the soldering operation.

Maintaining the data 220 may refer to keeping the data associated with the high priority in the marked SLC 205 or the SLC 210 (e.g., in a SLC). That is, the memory system 200 may read the data stored in the marked SLC 205, correct errors in the data, and store the data (e.g., again, for a second time) in the marked SLC 205. In other examples, the memory system 200 may transfer data 225 associated with a relatively low priority level (e.g., a lower priority level than the high priority data) from the SLC 210 to the TLC 215 after the soldering operation. By maintaining the data 220 in the marked SLC 205, the memory system 200 may support reduced latency associated with reading out the data. For example, because data stored in SLC rather than TLC (e.g., or QLC) is associated with faster readout times, the memory system 200 may read out the data from the marked SLC 205 faster than data transferred to the TLC 215 during the refresh operation.

Additionally, or alternatively, the memory system 200 may support the reduced latency by pre-fetching the data during a boot-up procedure (e.g., a system boot-up). Pre-fetching may refer to a transfer of data to a buffer 230 prior to receipt of a read command. For example, during the boot-up procedure, the memory system 200 may pre-load the data to the buffer 230 prior to receiving a read command from the host system. That is, the memory system 200 may transfer the data associated with the high priority level (e.g., HHPD) from the marked SLC 205 to the buffer 230. That is, the memory system 200 may transfer the data from the marked SLC 205 to the buffer 230 in accordance with the parameter in the write command.

In some examples, the memory system 200 may pre-load the data to the buffer 230 in response to transitioning from a first power state to a second power state. For example, the boot-up procedure may involve transitioning from the first power state (e.g., power off, relatively low power) to the second power state (e.g., power on, relatively higher power). By transferring the data associated with the high priority level to the buffer 230 prior to receipt of the read command, the memory system 200 may reduce a latency associated with reading out the data during the boot-up procedure. For example, because the data may be in the buffer 230 before the read command is received, the memory system may transfer the data from the buffer 230 to the host system rather than from the marked SLC 205 to the buffer 230 and then to the host system.

In some examples, the host system may update the set of LBAs which are tagged by the host system as being high priority. For example, the host system may update the reserved LBAs via a tagging method. Reserved LBAs may refer to locations within the memory system, such as in the marked SLC 205, which may be used to store the high priority data (e.g., but not other data). That is, the set of LBAs may be “reserved” for the high priority data. The tagging method may refer to inclusion of the parameter (e.g., the group number) in a write command sent to the memory system 200. The memory system 200 may update a mapping associated with the high priority level (e.g., the HHPD) in response to receiving the write command including the updated set of LBAs. In examples in which the host system updates the set of LBAs before sending a read command, the memory system 200 may transfer the data associated with the updated set of LBAs to the buffer 230. For example, the memory system 200 may pre-fetch the data associated with the updated set of LBAs after device-under-test (DUT) loading. Additionally, or alternatively, the host system may update the set of LBAs after sending the read command, and the memory system 200 may maintain the data associated with the updated set of LBAs in the marked SLC 205 and transfer the data to the buffer 230 prior to a second read command (e.g., pre-fetch the data). For example, the memory system 200 may pre-fetch the data during a subsequent boot-up procedure.

The memory system 200 may transfer the data from the buffer 230 to the host system in accordance with a counter, such as a hit quality parameter (HQP). For example, the HQP may be associated with a relationship between the prefetching and cache hits (e.g., buffer hits). The HQP may be calculated according to Equation 1 below, where p may represent a percentage of high priority LBAs confirmed after an update to the host system, HQP_{curr} may refer to a current HQP value, and HQP_{Init} may refer to an initial HQP value. That is, p may represent a portion of prefetched data retrieved by the host system.

$$HQP ( p ) = \frac{H Q {P}_{c u r r} - H Q {P}_{Init}}{100} \cdot p + {HQP}_{Init} \qquad ( 1 )$$

The memory system 200 may perform pre-fetching in accordance with the HQP being above a first threshold (e.g., an upper threshold). For example, the memory system 200 may increment a value of a counter (e.g., increase the HQP) in response to transferring the data from the buffer 230 to the host system. That is, the HQP according to Equation 1 may increase in response to p, the portion of prefetched data retrieved by the host system, increasing, and the memory system 200 may continue to perform pre-fetching (e.g., for a second time, prior to a second read command, etc.) in response to the pre-fetched data being read.

In other examples, the memory system 200 may refrain from performing the pre-fetching in accordance with the HQP being below a second threshold (e.g., a lower threshold). For example, the memory system 200 may decrement a value of the counter (e.g., decrease the HQP) in response to failing to transfer the data from the buffer 230 to the host system. In other words, the HQP according to Equation 1 may decrease in response to p, the portion of prefetched data retrieved by the host system, decreasing, and the memory system 200 may refrain from performing pre-fetching (e.g., for a second time, prior to a second read command, etc.) in response to the pre-fetched data not being read. By transferring the data to the buffer 230 prior to receiving the read command and by storing the data associated with the priority level in the first type of memory cells, the memory system 200 may reduce a latency associated with loading the firmware image during the boot-up procedure.

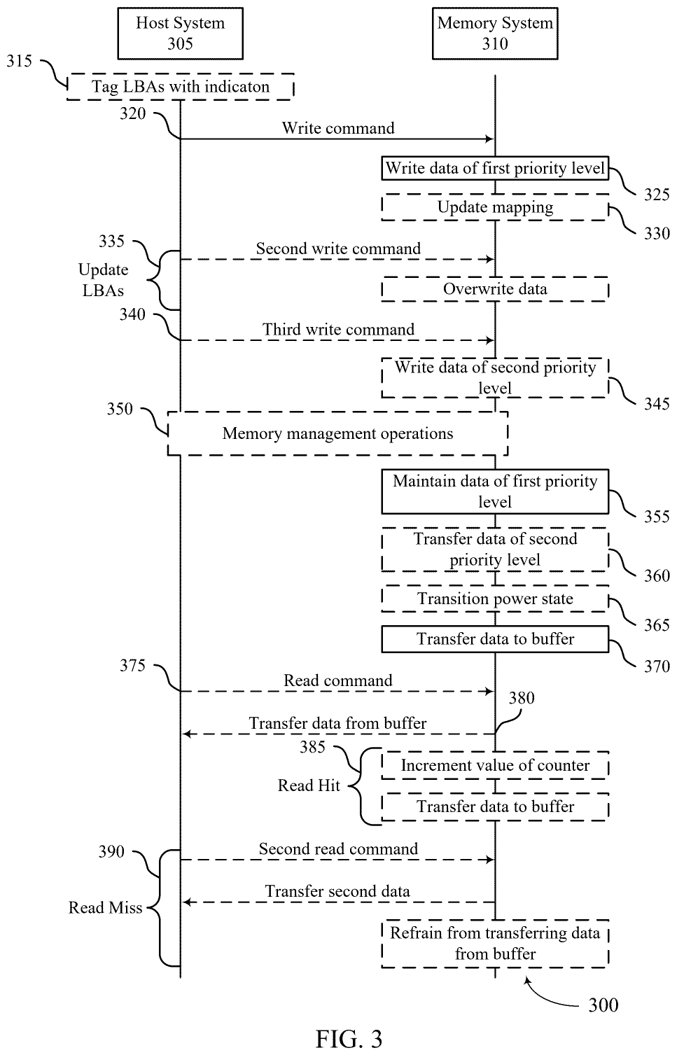

FIG. 3 shows an example of a process 300 that supports data prioritization for boot-up procedures in accordance with examples as disclosed herein. In some examples, the process 300 may implement or be implemented by aspects of the system 100, the memory system 200, or both. For example, the process 300 may include a host system 305 and a memory system 310, which may be examples of corresponding systems as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the host system 305 and the memory system 310 are shown performing the operations of the process 300, some aspects of some operations may also be performed by one or more other systems or devices.

Aspects of the process 300 may be implemented by one or more controllers, among other components. Additionally, or alternatively, aspects of the process 300 may be implemented as instructions stored in one or more memories. For example, the instructions, when executed by one or more controllers, may cause the one or more controllers (or a device or a system) to perform the operations of the process 300.

At 315, one or more LBAs may be tagged with an indication. In some examples, the host system 305 may tag LBAs with an indication. For example, the host system 305 may include, for a set of LBAs, an indication that data of a first priority level (e.g., high priority data) is associated with the set of LBAs.

At 320, a write command may be received. In some examples, the memory system 310 may receive a write command to write data used during a boot-up procedure of the memory system 310, where the write command includes an indication that the data is associated with a first priority level. The write command may be associated with the set of LBAs. For example, the indication that the data is associated with the first priority level may be associated with the set of LBAs (e.g., the tagged LBAs of 315). In some examples, the indication includes a group number associated with the first priority level.

At 325, data of the first priority level may be written. In some examples, the memory system 310 may write data of the first priority level. For example, the memory system 310 may write the data to a first block of memory cells of a first type in accordance with the indication that the data is associated with the first priority level. In some examples, the first block of memory cells of the first type may include memory cells configured to store a single bit of data (e.g., SLC). The first block of the memory cells of the first type may be an example of the marked SLC 205 or the SLC 210 as described with reference to FIG. 2.

At 330, a mapping may be updated. In some examples, the memory system 310 may update the mapping (e.g., update HHPD). For example, the memory system 310 may update a mapping between the set of LBAs and the first block of memory cells to indicate that the data is associated with the first priority level in response to receiving the write command at 320.

At 335, one or more operations may be performed in accordance with updating the set of LBAs. In some examples, the host system 305 and the memory system 310 may perform the one or more operations in accordance with updating the set of LBAs. For example, the memory system 310 may receive a second write command including third data to be written to the first block of memory cells of the memory system 310, where the second write command includes an indication that the third data is associated with the first priority level. In response to receiving the second write command, the memory system 310 may overwrite, prior to receiving the read command (e.g., at 375), the data with the third data.

At 340, a third write command may be received. In some examples, the memory system 310 may receive a third write command including fourth data to be written to the memory system, where the fourth data is associated with a second priority level (e.g., a low priority level) different than the first priority level. For example, the fourth data may be associated with a group number different than the group number associated with the first data. At 345, data of the second priority level may be written. For example, in response to receiving the third write command at 340, at 345, the memory system 310 may write the fourth data to a third block of memory cells of the first type. The third block of memory cells of the first type may be an example of the SLC 210 as described with reference to FIG. 2.

At 350, memory management operations may be performed. For example, the one or more memory management operations may include a soldering operation. In some examples, the one or more memory management operations may be part of a manufacturing operation.

At 355, the data of the first priority level may be maintained. For example, the memory system 310 may maintain, after the one or more memory management operations at 350, the data in a block of memory cells of the first type in response to writing the data to the first block of memory cells. In some examples, maintaining the data may include maintaining the data in the first block of memory cells of the first type. Alternatively, maintaining the data may include transferring the data from the first block of memory cells of the first type to a second block of memory cells of the first type. That is, the memory system 310 may store the data in SLC prior to and after the one or more memory management operations.

At 360, the data of the second priority level may be transferred. In some examples, the memory system 310 may transfer, after the one or more memory management operations at 350, the fourth data to a fourth block of memory cells of a second type. For example, the second type may be an example of the TLC 215 as described with reference to FIG. 2.

At 365, a power state may transition. In some examples, the memory system 310 may transition from a first power state to a second power state, where transferring the data to the buffer (e.g., at 370) is in response to the memory system 310 transitioning from the first power state to the second power state. For example, the memory system 310 may transition from the first power state to the second power state during a boot sequence (e.g., a boot-up procedure).

At 370, data may be transferred to a buffer. For example, the memory system 310 may transfer, prior to receiving a read command (e.g., at 375) for the data during the boot sequence and in accordance with the data being associated with the first priority level, the data to a buffer of the memory system 310. The buffer may be an example of the buffer 230 as described with reference to FIG. 2. In some examples, transferring the data to the buffer of the memory system 310 may be in accordance with the mapping (e.g., updated at 330) indicating that the data is associated with the first priority level.

At 375, a read command may be received. For example, the memory system 310 may receive the read command in response to transferring the data to the buffer at 370. At 380, data may be transferred from the buffer. For example, in response to receiving the read command at 375, at 380, the memory system 301 may transfer the data from the buffer to the host system 305.

At 385, a read hit may occur. In some examples, the memory system 310 may perform one or more operations according to a read hit. For example, the memory system 310 may increment a value of a counter (e.g., an HQP) in response to transferring the data from the buffer to the host system 305 (e.g., at 380). Additionally, or alternatively, the memory system 310 may transfer, for a second time and prior to receiving a second read command (e.g., at 390), the data to the buffer of the memory system 310 in accordance with the value of the counter being above a first threshold value. In other words, the memory system 310 may continue to pre-fetch data in accordance with the read hit and the value of the counter being above the first threshold value (e.g., a high threshold).

At 390, a read miss may occur. In some examples, the host system 305 and the memory system 310 may perform one or more operations according to a read miss. For example, the memory system 310 may receive a second read command for second data in response to transferring the data to the buffer (e.g., at 370). The memory system 310 may transfer the second data to the host system 305 in response to receiving the second read command. The memory system 310 may refrain from transferring the data from the buffer to the host system 305 in response to receiving the second read command. In some examples, the memory system 310 may decrement a value of the counter in response to refraining from transferring the data from the buffer to the host system 305. Additionally, or alternatively, the memory system may refrain from transferring the data to the buffer of the memory system 310 for a second time in accordance with the value of the counter being below a second threshold value. In other words, the memory system 310 may stop pre-fetching data in accordance with the read miss and the value of the counter being below the second threshold value (e.g., a low threshold).

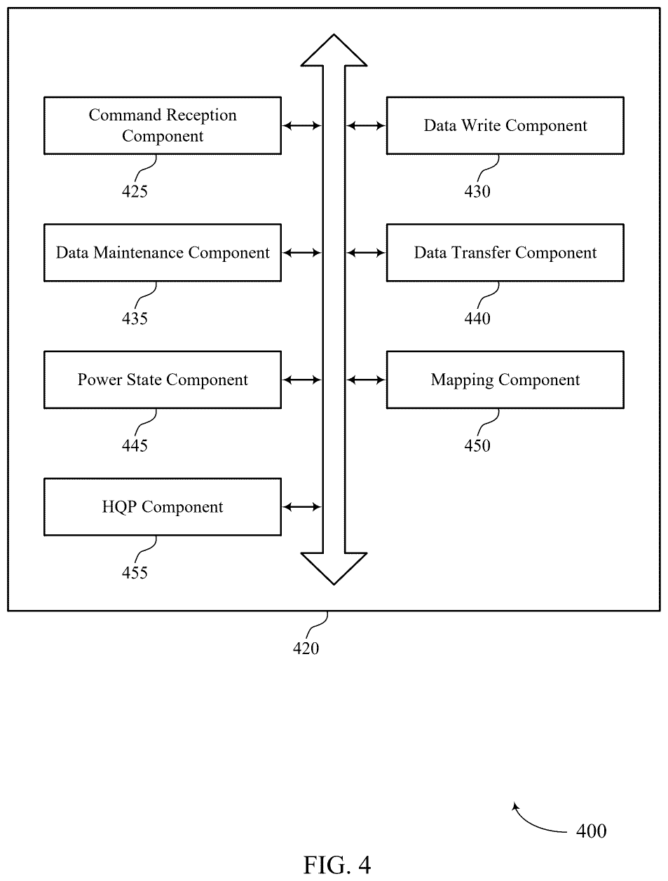

FIG. 4 shows a block diagram 400 of a memory system 420 that supports data prioritization for boot-up procedures in accordance with examples as disclosed herein. The memory system 420 may be an example of aspects of a memory system as described with reference to FIGS. 1 through 3. The memory system 420, or various components thereof, may be an example of means for performing various aspects of data prioritization for boot-up procedures as described herein. For example, the memory system 420 may include a command reception component 425, a data write component 430, a data maintenance component 435, a data transfer component 440, a power state component 445, a mapping component 450, an HQP component 455, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a write command to write data used during a boot-up procedure of the memory system, where the write command includes an indication that the data is associated with a first priority level. The data write component 430 may be configured as or otherwise support a means for writing the data to a first block of memory cells of a first type in accordance with the indication that the data is associated with the first priority level. The data maintenance component 435 may be configured as or otherwise support a means for maintaining, after one or more memory management operations, the data in a block of memory cells of the first type in response to writing the data to the first block of memory cells. The data transfer component 440 may be configured as or otherwise support a means for transferring, prior to receiving a read command for the data during the boot-up procedure and in accordance with the data being associated with the first priority level, the data to a buffer of the memory system.

In some examples, the one or more memory management operations includes a soldering operation.

In some examples, the write command is associated with a set of LBAs. In some examples, the indication that the data is associated with the first priority level is associated with the set of LBAs.

In some examples, the mapping component 450 may be configured as or otherwise support a means for updating a mapping between the set of LBAs and the first block of memory cells to indicate that the data is associated with the first priority level in response to receiving the write command, where transferring the data to the buffer of the memory system is in accordance with the mapping indicating that the data is associated with the first priority level.

In some examples, the command reception component 425 may be configured as or otherwise support a means for receiving the read command in response to transferring the data to the buffer. In some examples, the data transfer component 440 may be configured as or otherwise support a means for transferring the data from the buffer to a host system in response to receiving the read command.

In some examples, the HQP component 455 may be configured as or otherwise support a means for incrementing a value of a counter in response to transferring the data from the buffer to the host system. In some examples, the data transfer component 440 may be configured as or otherwise support a means for transferring, for a second time and prior to receiving a second read command, the data to the buffer of the memory system in accordance with the value of the counter being above a first threshold value.

In some examples, the command reception component 425 may be configured as or otherwise support a means for receiving a second read command for second data in response to transferring the data to the buffer. In some examples, the data transfer component 440 may be configured as or otherwise support a means for transferring the second data to a host system in response to receiving the second read command. In some examples, the data transfer component 440 may be configured as or otherwise support a means for refraining from transferring the data from the buffer to the host system in response to receiving the second read command.

In some examples, the HQP component 455 may be configured as or otherwise support a means for decrementing a value of a counter in response to refraining from transferring the data from the buffer to the host system. In some examples, the data transfer component 440 may be configured as or otherwise support a means for refraining from transferring the data to the buffer of the memory system for a second time in accordance with the value of the counter being below a second threshold value.

In some examples, the command reception component 425 may be configured as or otherwise support a means for receiving a second write command including third data to be written to the first block of memory cells of the memory system, where the second write command includes an indication that the third data is associated with the first priority level. In some examples, the data write component 430 may be configured as or otherwise support a means for overwriting, prior to receiving the read command, the data with the third data in response to receiving the second write command.

In some examples, the indication includes a group number associated with the first priority level.

In some examples, the first block of memory cells of the first type includes memory cells configured to store a single bit of data.

In some examples, the command reception component 425 may be configured as or otherwise support a means for receiving a third write command including fourth data to be written to the memory system, where the fourth data is associated with a second priority level different than the first priority level. In some examples, the data write component 430 may be configured as or otherwise support a means for writing the fourth data to a third block of memory cells of the first type in response to receiving the third write command. In some examples, the data transfer component 440 may be configured as or otherwise support a means for transferring, after the one or more memory management operations, the fourth data to a fourth block of memory cells of a second type.

In some examples, the power state component 445 may be configured as or otherwise support a means for transitioning, by the memory system, from a first power state to a second power state, where transferring the data to the buffer is in response to the memory system transitioning from the first power state to the second power state.

In some examples, to support maintaining the data in the block of memory cells of the first type, the data maintenance component 435 may be configured as or otherwise support a means for maintaining the data in the first block of memory cells of the first type.

In some examples, to support maintaining the data in the block of memory cells of the first type, the data transfer component 440 may be configured as or otherwise support a means for transferring the data from the first block of memory cells of the first type to a second block of memory cells of the first type.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

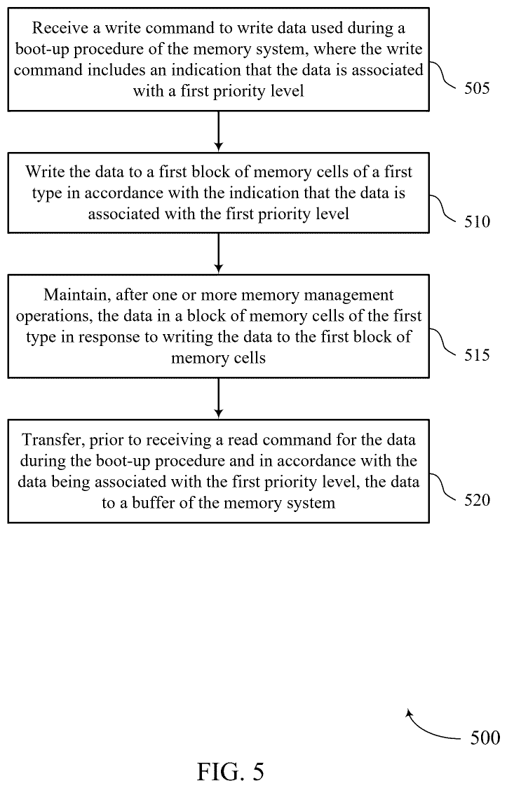

FIG. 5 shows a flowchart illustrating a method 500 that supports data prioritization for boot-up procedures in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a write command to write data used during a boot-up procedure of the memory system, where the write command includes an indication that the data is associated with a first priority level. In some examples, aspects of the operations of 505 may be performed by a command reception component 425 as described with reference to FIG. 4.

At 510, the method may include writing the data to a first block of memory cells of a first type in accordance with the indication that the data is associated with the first priority level. In some examples, aspects of the operations of 510 may be performed by a data write component 430 as described with reference to FIG. 4.

At 515, the method may include maintaining, after one or more memory management operations, the data in a block of memory cells of the first type in response to writing the data to the first block of memory cells. In some examples, aspects of the operations of 515 may be performed by a data maintenance component 435 as described with reference to FIG. 4.

At 520, the method may include transferring, prior to receiving a read command for the data during the boot-up procedure and in accordance with the data being associated with the first priority level, the data to a buffer of the memory system. In some examples, aspects of the operations of 520 may be performed by a data transfer component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command to write data used during a boot-up procedure of the memory system, where the write command includes an indication that the data is associated with a first priority level; writing the data to a first block of memory cells of a first type in accordance with the indication that the data is associated with the first priority level; maintaining, after one or more memory management operations, the data in a block of memory cells of the first type in response to writing the data to the first block of memory cells; and transferring, prior to receiving a read command for the data during the boot-up procedure and in accordance with the data being associated with the first priority level, the data to a buffer of the memory system.

Aspect 2: The method, apparatus, or non-transitory computer-readable medium of aspect 1, where the one or more memory management operations includes a soldering operation.

Aspect 3: The method, apparatus, or non-transitory computer-readable medium of any of aspects 1 through 2, where the write command is associated with a set of LBAs and the indication that the data is associated with the first priority level is associated with the set of LBAs.

Aspect 4: The method, apparatus, or non-transitory computer-readable medium of aspect 3, further including operations, features, circuitry, logic, means, or instructions, or any combination thereof for updating a mapping between the set of LBAs and the first block of memory cells to indicate that the data is associated with the first priority level in response to receiving the write command, where transferring the data to the buffer of the memory system is in accordance with the mapping indicating that the data is associated with the first priority level.

Aspect 5: The method, apparatus, or non-transitory computer-readable medium of any of aspects 1 through 4, further including operations, features, circuitry, logic, means, or instructions, or any combination thereof for receiving the read command in response to transferring the data to the buffer and transferring the data from the buffer to a host system in response to receiving the read command.

Aspect 6: The method, apparatus, or non-transitory computer-readable medium of aspect 5, further including operations, features, circuitry, logic, means, or instructions, or any combination thereof for incrementing a value of a counter in response to transferring the data from the buffer to the host system and transferring, for a second time and prior to receiving a second read command, the data to the buffer of the memory system in accordance with the value of the counter being above a first threshold value.

Aspect 7: The method, apparatus, or non-transitory computer-readable medium of any of aspects 1 through 6, further including operations, features, circuitry, logic, means, or instructions, or any combination thereof for receiving a second read command for second data in response to transferring the data to the buffer; transferring the second data to a host system in response to receiving the second read command; and refraining from transferring the data from the buffer to the host system in response to receiving the second read command.

Aspect 8: The method, apparatus, or non-transitory computer-readable medium of aspect 7, further including operations, features, circuitry, logic, means, or instructions, or any combination thereof for decrementing a value of a counter in response to refraining from transferring the data from the buffer to the host system and refraining from transferring the data to the buffer of the memory system for a second time in accordance with the value of the counter being below a second threshold value.

Aspect 9: The method, apparatus, or non-transitory computer-readable medium of any of aspects 1 through 8, further including operations, features, circuitry, logic, means, or instructions, or any combination thereof for receiving a second write command including third data to be written to the first block of memory cells of the memory system, where the second write command includes an indication that the third data is associated with the first priority level and overwriting, prior to receiving the read command, the data with the third data in response to receiving the second write command.

Aspect 10: The method, apparatus, or non-transitory computer-readable medium of any of aspects 1 through 9, where the indication includes a group number associated with the first priority level.

Aspect 11: The method, apparatus, or non-transitory computer-readable medium of any of aspects 1 through 10, where the first block of memory cells of the first type includes memory cells configured to store a single bit of data.

Aspect 12: The method, apparatus, or non-transitory computer-readable medium of any of aspects 1 through 11, further including operations, features, circuitry, logic, means, or instructions, or any combination thereof for receiving a third write command including fourth data to be written to the memory system, where the fourth data is associated with a second priority level different than the first priority level; writing the fourth data to a third block of memory cells of the first type in response to receiving the third write command; and transferring, after the one or more memory management operations, the fourth data to a fourth block of memory cells of a second type.

Aspect 13: The method, apparatus, or non-transitory computer-readable medium of any of aspects 1 through 12, further including operations, features, circuitry, logic, means, or instructions, or any combination thereof for transitioning, by the memory system, from a first power state to a second power state, where transferring the data to the buffer is in response to the memory system transitioning from the first power state to the second power state.

Aspect 14: The method, apparatus, or non-transitory computer-readable medium of any of aspects 1 through 13, where maintaining the data in the block of memory cells of the first type includes operations, features, circuitry, logic, means, or instructions, or any combination thereof for maintaining the data in the first block of memory cells of the first type.

Aspect 15: The method, apparatus, or non-transitory computer-readable medium of any of aspects 1 through 14, where maintaining the data in the block of memory cells of the first type includes operations, features, circuitry, logic, means, or instructions, or any combination thereof for transferring the data from the first block of memory cells of the first type to a second block of memory cells of the first type.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field- effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command to write data used during a boot-up procedure of the memory system, wherein the write command comprises an indication that the data is associated with a first priority level;
write the data to a first block of memory cells of a first type in accordance with the indication that the data is associated with the first priority level;
maintain, after one or more memory management operations, the data in a block of memory cells of the first type in response to writing the data to the first block of memory cells; and
transfer, prior to receiving a read command for the data during the boot-up procedure and in accordance with the data being associated with the first priority level, the data to a buffer of the memory system.

2. The memory system of claim 1, wherein the one or more memory management operations comprises a soldering operation.

3. The memory system of claim 1, wherein:
the write command is associated with a set of logical block addresses, and
the indication that the data is associated with the first priority level is associated with the set of logical block addresses.

4. The memory system of claim 3, wherein the processing circuitry is further configured to cause the memory system to:
update a mapping between the set of logical block addresses and the first block of memory cells to indicate that the data is associated with the first priority level in response to receiving the write command, wherein transferring the data to the buffer of the memory system is in accordance with the mapping indicating that the data is associated with the first priority level.

5. The memory system of claim 1, wherein the processing circuitry is further configured to cause the memory system to:
receive the read command in response to transferring the data to the buffer; and
transfer the data from the buffer to a host system in response to receiving the read command.

6. The memory system of claim 5, wherein the processing circuitry is further configured to cause the memory system to:
increment a value of a counter in response to transferring the data from the buffer to the host system; and
transfer, for a second time and prior to receiving a second read command, the data to the buffer of the memory system in accordance with the value of the counter being above a first threshold value.

7. The memory system of claim 1, wherein the processing circuitry is further configured to cause the memory system to:
receive a second read command for second data in response to transferring the data to the buffer;
transfer the second data to a host system in response to receiving the second read command; and
refrain from transferring the data from the buffer to the host system in response to receiving the second read command.

8. The memory system of claim 7, wherein the processing circuitry is further configured to cause the memory system to:
decrement a value of a counter in response to refraining from transferring the data from the buffer to the host system; and
refrain from transferring the data to the buffer of the memory system for a second time in accordance with the value of the counter being below a second threshold value.

9. The memory system of claim 1, wherein the processing circuitry is further configured to cause the memory system to:
receive a second write command comprising third data to be written to the first block of memory cells of the memory system, wherein the second write command comprises an indication that the third data is associated with the first priority level; and
overwrite, prior to receiving the read command, the data with the third data in response to receiving the second write command.

10. The memory system of claim 1, wherein the indication comprises a group number associated with the first priority level.

11. The memory system of claim 1, wherein the first block of memory cells of the first type comprises memory cells configured to store a single bit of data.

12. The memory system of claim 1, wherein the processing circuitry is further configured to cause the memory system to:
receive a third write command comprising fourth data to be written to the memory system, wherein the fourth data is associated with a second priority level different than the first priority level;
write the fourth data to a third block of memory cells of the first type in response to receiving the third write command; and
transfer, after the one or more memory management operations, the fourth data to a fourth block of memory cells of a second type.

13. The memory system of claim 1, wherein the processing circuitry is further configured to cause the memory system to:
transition, by the memory system, from a first power state to a second power state, wherein transferring the data to the buffer is in response to the memory system transitioning from the first power state to the second power state.

14. The memory system of claim 1, wherein maintaining the data in the block of memory cells of the first type comprises the processing circuitry configured to cause the memory system to:
maintain the data in the first block of memory cells of the first type.

15. The memory system of claim 1, wherein maintaining the data in the block of memory cells of the first type comprises the processing circuitry configured to cause the memory system to:
transfer the data from the first block of memory cells of the first type to a second block of memory cells of the first type.

16. A non-transitory computer-readable medium storing code comprising instructions which, when executed by one or more processors of a memory system, cause the memory system to:
receive a write command to write data used during a boot-up procedure of the memory system, wherein the write command comprises an indication that the data is associated with a first priority level;
write the data to a first block of memory cells of a first type in accordance with the indication that the data is associated with the first priority level;
maintain, after one or more memory management operations, the data in a block of memory cells of the first type in response to writing the data to the first block of memory cells; and
transfer, prior to receiving a read command for the data during the boot-up procedure and in accordance with the data being associated with the first priority level, the data to a buffer of the memory system.

17. The non-transitory computer-readable medium of claim 16, wherein the one or more memory management operations comprises a soldering operation.

18. The non-transitory computer-readable medium of claim 16, wherein:
the write command is associated with a set of logical block addresses, and
the indication that the data is associated with the first priority level is associated with the set of logical block addresses.

19. The non-transitory computer-readable medium of claim 18, wherein the instructions, when executed by the one or more processors of the memory system, further cause the memory system to:
update a mapping between the set of logical block addresses and the first block of memory cells to indicate that the data is associated with the first priority level in response to receiving the write command, wherein transferring the data to the buffer of the memory system is in accordance with the mapping indicating that the data is associated with the first priority level.

20. The non-transitory computer-readable medium of claim 16, wherein the instructions, when executed by the one or more processors of the memory system, further cause the memory system to:
receive the read command in response to transferring the data to the buffer; and
transfer the data from the buffer to a host system in response to receiving the read command.

21. The non-transitory computer-readable medium of claim 20, wherein the instructions, when executed by the one or more processors of the memory system, further cause the memory system to:
increment a value of a counter in response to transferring the data from the buffer to the host system; and
transfer, for a second time and prior to receiving a second read command, the data to the buffer of the memory system in accordance with the value of the counter being above a first threshold value.

22. The non-transitory computer-readable medium of claim 16, wherein the instructions, when executed by the one or more processors of the memory system, further cause the memory system to:
receive a second read command for second data in response to transferring the data to the buffer;
transfer the second data to a host system in response to receiving the second read command; and
refrain from transferring the data from the buffer to the host system in response to receiving the second read command.

23. The non-transitory computer-readable medium of claim 22, wherein the instructions, when executed by the one or more processors of the memory system, further cause the memory system to:
decrement a value of a counter in response to refraining from transferring the data from the buffer to the host system; and
refrain from transferring the data to the buffer of the memory system for a second time in accordance with the value of the counter being below a second threshold value.

24. The non-transitory computer-readable medium of claim 16, wherein the instructions, when executed by the one or more processors of the memory system, further cause the memory system to:
receive a second write command comprising third data to be written to the first block of memory cells of the memory system, wherein the second write command comprises an indication that the third data is associated with the first priority level; and
overwrite, prior to receiving the read command, the data with the third data in response to receiving the second write command.

25. A method by a memory system, comprising:
receiving a write command to write data used during a boot-up procedure of the memory system, wherein the write command comprises an indication that the data is associated with a first priority level;
writing the data to a first block of memory cells of a first type in accordance with the indication that the data is associated with the first priority level;
maintaining, after one or more memory management operations, the data in a block of memory cells of the first type in response to writing the data to the first block of memory cells; and
transferring, prior to receiving a read command for the data during the boot-up procedure and in accordance with the data being associated with the first priority level, the data to a buffer of the memory system.
